(19) United States
(12) Patent Application Publication
(10) Pub. No.: US 2006/0203733 A1
(43) Pub. Date: Sep. 14, 2006

(54) Methods, apparatuses, and articles to remotely test communications networks using digital fingerprints of content

(75) Inventors: Colin Grant, Blacksburg, VA (US); Benedetto Castrogiovanni, Bellevue, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Casabyte, Inc., Renton, WA (US)

(21) Appl. No.: 11/355,505

(22) Filed: Feb. 16, 2006

Related U.S. Application Data
(60) Provisional application No. 60/654,526, filed on Feb. 17, 2005.

(51) Int. Cl. H04L 12/26

(52) U.S. Cl. 370/241

(57) ABSTRACT

A remote testing system employs digital fingerprinting in order to recognize with a determined degree of certainty, multimedia content transmitted over a target communications network being tested, for example a cellular communications network, without requiring the transmission of a reference copy of the content to the comparison equipment.

### CROSS-REFERENCE TO RELATED APPLICATIONS

This application claims benefit under 35 U.S.C. 119(e) to U.S. Provisional Patent Application Ser. No. 60/654,526 filed Feb. 17, 2005.

### BACKGROUND OF THE INVENTION

1. Field of the Invention

This disclosure generally relates to communications, for example, cellular telecommunications, and more particularly to the testing of communications networks and/or equipment.

2. Description of the Related Art

The use of wireless communications is rapidly growing. Wireless communications devices such as cellular phones and wireless personal digital assistants (“PDAs”) are ubiquitous. These devices transmit and/or receive audio and/or data wirelessly. For example, cellular phones may transmit and receive audio and text messaging, and may even allow access to the Internet. PDAs typically transmit and/or receive electronic mail (“e-mail”) and may provide access to the Worldwide Web (“WWW”), and/or audio or video files such as files in the MP3 format.

The wireless communications devices rely on wireless communications service providers for providing subscribed services. The wireless communications service providers operate wireless communications service provider systems or networks that provide for registration, authentication, location updating, handovers, and call routing. Wireless communications service provider networks typically employ a Home Location Register (“HLR”) and a Visitor Location Register (“VLR”) to provide call routing and roaming. The HLR contains administrative information for each subscriber registered with the wireless communications service provider, along with current location information for a wireless communications device currently associated with the subscriber. The VLR contains selected administrative information from the HLR that is required for call control and for providing subscribed services for each wireless communications device currently within a geographical area service by the VLR.

Wireless communications networks and their constituent devices require testing to assure performance. One method of testing is to physically transit portions of the area covered by the wireless communications system while operating a wireless communications device. Another approach employs remotely operated test platforms that are pre-positioned at a variety of locations in the wireless communications coverage area. The remote test platforms typically include two or more wireless communications devices that may be controlled by one or more local or central controllers to place and receive calls in selected coverage areas. Various details of remote testing are taught in U.S. Pat. Nos. 5,875,398; 6,230,006; 6,430,410; 6,542,738; 6,788,934, and 6,836,670.

The unrelated area of digital rights management has commercially adopted techniques that employ perceptual algorithms to generate digital fingerprints of content. The digital fingerprints are used to find matches within reference databases for information about the identified content. For example, a copyright policing organization (e.g., Audible Magic Corporation of Los Gatos, Calif.) may create digital fingerprints of a number of songs in the organization's catalog (e.g., a collection of copyrighted materials such as songs for which the organization is responsible for collecting and/or monitoring royalty payments for the copyright holder). The organization monitors the broadcasts of a number of media outlets, for example radio stations. The digital fingerprint allows the organization to automatically monitor the broadcasts using automated equipment to track information about the various materials in the organization's catalog. For example, the digital fingerprint may be used for tracking the number of times a song is played by a particular radio station. The use of the perceptual algorithm allows matches to be found, even when a song is performed by different artists and/or arranged differently. The use of the digital fingerprint limits allows the use of automated equipment, limiting the amount of matching that must be automatically performed, and thereby allowing faster and more computationally efficient processing. Various details of perceptual digital fingerprinting are taught in U.S. Pat. Nos. 5,918,223, 6,834,308, and 6,968,337 as well as in U.S. patent application Publication Ser. Nos. 2003/18709; 2003/33321; 2003/37010; 2003/135623; and 2004/163106.

### BRIEF SUMMARY OF THE INVENTION

In one aspect, perceptual fingerprinting algorithms are employed in providing a novel solution to a problem specific to the communications test market. In another aspect, audio fingerprints are used to differentiate between different audio samples and establish the confidence factor, for example at remote test sites. In yet another aspect, video fingerprints are used to differentiate between different video samples and establish the confidence factor, for example at remote test sites. In still another aspect, multimedia messaging service (MMS) fingerprints are used to differentiate between different MMS samples and establish the confidence factor, for example at remote test sites. In yet still another aspect, sets of audio fingerprints are used to determine the current menu for Interactive Voice response (IVR) testing, within an acceptable confidence factor, for example at remote test sites.

In one embodiment, a method for testing a target communications network comprises: causing content to be transmitted from a content source to a test platform via the target communications network that is being tested; producing a digital fingerprint representative of the content received at the test platform via the target communications network; comparing the digital fingerprint of the content received at the test platform via the target communications network to a reference digital fingerprint of the content, where the reference digital fingerprint of the content is representative of the content caused to be transmitted; and determining based at least in part on the comparison of the digital fingerprint of the content received at the test platform via the target communications network to a reference digital fingerprint of the content whether the content as received via the target communications network matches the content caused to be transmitted, within a defined degree of confidence. The method can transmit the reference digital fingerprint to the test platform for the comparison, or can return the digital fingerprint of the content that was transmitted via the subject communications network to a test control system for the comparison.

In another aspect a method for testing a target cellular telecommunications network comprises: as part of a test, identifying content to be transmitted from a content source to a test platform via the target cellular telecommunications network that is being tested; receiving transmitted content at a first one of the test platforms via the target cellular telecommunications network that is being tested; at the first one of the test platforms, producing a digital fingerprint representative of the transmitted content as received at the test platform via the target cellular telecommunications network; and comparing the digital fingerprint representative of the transmitted content as received at the test platform via the target cellular telecommunications network with a reference digital fingerprint known before the comparison to correspond to the identified content to be transmitted, where the reference digital fingerprint is representative of the identified content to be transmitted without having traversed the target cellular telecommunications network.

In a further aspect, a system for remotely testing a target communications network comprises: means for indicating content to be transmitted from a content source to a test platform via the target communications network that is being tested; means for generating a digital fingerprint representative of a transmitted content as received via the target communications network; and means for comparing the digital fingerprint representative of the transmitted content as received via the target communications network with a reference digital fingerprint, the reference digital fingerprint known prior to the comparing to be representative of the content indicated by the means for indicating.

In yet a further aspect, a system for remotely testing a target cellular telecommunications network comprises: a plurality of test platforms geographically dispersed in at least a portion of a range of the target cellular telecommunications network, the test platforms operable to receive multimedia content via the target cellular telecommunications network, and further operable to produce a digital fingerprint of the multimedia content as received by the test platform over the target cellular telecommunications network; and a test control system operable to identify multimedia content for transmission via the target cellular telecommunications network, and further operable to provide information indicative of a correspondence within a defined degree of confidence between an identity of the multimedia content received over at least a portion of the target cellular telecommunications network and the multimedia content identified for transmission based at least in part on a comparison of the digital fingerprint of the multimedia content received over at least a portion of the target cellular telecommunications network with a respective reference digital fingerprint known before the comparison to correspond to the multimedia content identified for transmission via the target cellular telecommunications network.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements, as drawn, are not intended to convey any information regarding the actual shape of the particular elements, and have been solely selected for ease of recognition in the drawings.

FIG. 1 is a schematic diagram of a test system for remotely testing a targeted communications network, the test system including a test controller and one or more remote test platforms remotely located from the test controller which are operable to compare a digital fingerprint of content received at the test platform via the target communications network with a reference digital fingerprint, according to one illustrated embodiment.

FIG. 2 is a schematic diagram of a test system for remotely testing a targeted communications network, the test system including a test controller and one or more remote test platforms remotely located from the test controller which are operable to provide a digital fingerprint of content received at the test platform via the target communications network to a comparison subsystem for comparison with a reference digital fingerprint, according to another illustrated embodiment.

FIG. 3 is a schematic diagram of a test system for remotely testing a targeted communications network, the test system including a test controller and one or more remote test platforms remotely located from the test controller which are operable to provide a digital fingerprint of content received at the test platform via the target communications network to a comparison subsystem for comparison with a reference digital fingerprint, according to another illustrated embodiment.

FIG. 4 is a schematic diagram of a computing system which may be configured as a local or central test controller, a reference digital fingerprinting generating subsystem, scheduling subsystem and/or comparison subsystem of the test system of FIGS. 1-3.

FIG. 5 is a schematic diagram of a remote test platform having a pair of wireless communications devices, according to one embodiment.

FIG. 6 is a flow diagram showing a method of operating a test system such as that illustrated in FIGS. 1 or 3, to compare a received digital fingerprint with a reference digital fingerprint at the remote test platform, according to one illustrated embodiment.

FIG. 7 is a flow diagram showing a method of operating a test system such as that illustrated in FIGS. 2 or 3, to return a received digital fingerprint produced at the remote test platform for comparison with a reference digital fingerprint, according to one illustrated embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with communications networks, for example cellular telecommunications networks, remote test systems including remotely located test platforms, test controllers, and/or schedulers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

Previously, remote testing of content (e.g., multimedia content) transmitted over a target communications system under test either required a reference copy of the content to be transmitted to the measurement and comparison test equipment or for the received copy of the content to be transmitted from the measurement test equipment to another comparison point. Such an approach has a number of drawbacks. For example, the copying requires bandwidth to move the reference/received multimedia content through the test system network. Also for example, to ensure a faithful copy it is necessary to codify the content with additional overhead, which in turn consumes yet more bandwidth from the test system network.

Further, either the test system network is a separate adjunct network from the subject communications network under test, or the test system network uses the very same communications network under test. Either option has problems. For example, if a separate adjunct network is used, the increased bandwidth requirements require greater investment by the test system network owner and/or user. Also for example, if the same network is used then the increased bandwidth requirements can adversely affect and/or skew the test results for the subject communications network under test.

Telecommunication system providers are increasingly providing richer content through evolving multimedia formats and improving end user devices. The user experience is becoming more interactive. The user is intimately involved with the multimedia content to select other multimedia content. For example, audio prompts are used to guide a user through a voice mail system to retrieve or manipulate voice mail messages.

Previously, the reference/received multimedia content would be transported through the test system network. This causes latencies as the multimedia content volume is transported through the test system network bandwidth. When testing interactive state based response systems, the additional latency needed to transport original and codified multimedia content may cause the response systems to time out, either returning the test session to a known restarting point or even terminating the session.

Either response to the time out condition typically results in the test case failing. Thus the latency of transporting multimedia content during the test itself causes invalid test results. This in turn either causes test result information to be lost or the expense of rerunning the same test, which again may fail due to latency issues.

Latency problems may be solved by increasing the bandwidth of the test system network, but this results in a more expensive test infrastructure. The approach described herein may avoid the latency problem altogether, by using digital fingerprints to accurately represent the multimedia content using significantly less data. The digital fingerprint can be either transported through the test system network during the test itself, or, because of the significantly reduced volume of data, can be distributed prior to the test and stored in the test equipment in a timely and space efficient manner.

Perceptual fingerprinting algorithms generate a distinguishing fingerprint of the original digital content using significantly less amounts of data to represent and store the fingerprint compared to the original content. The perceptual nature of these algorithms allow the same fingerprint to be generated regardless of the quality of the transmitted content compared to the quality of the original content. These algorithms typically model what a human perceives at the end of the transmission. For example, these algorithms produce the same fingerprint for a CD quality music source, an FM radio recording, and a low sampling rate MP3 recording of the original source.

As discussed herein, common algorithms to calculate the digital fingerprints may be employed in test systems for remotely testing communications networks for test content and the source. The source transmits content over the target communications network under test to the remote test equipment, referred to herein as a remote test platform. The remote test platform uses the corresponding perceptual fingerprinting algorithm(s) to produce a digital fingerprint of the content as the content is received via the target communications network. The digital fingerprint of the received content is compared to a reference digital fingerprint to determine whether the right content was received at the remote test platform through the target communications network under test. In one embodiment, the reference digital fingerprint is transmitted to a remote test platform, which performs the comparison. Advantageously, the reference digital fingerprint rather than the actual content is transmitted to and/or stored at the remote test platform, addressing bandwidth and latency problems noted above. In another embodiment, the remote test platform transmits the digital fingerprint to a central element of the test system, which performs the comparison. Advantageously, only the digital fingerprint of the content as received via the subject communications network is transmitted to and/or stored at the central element of the test system, addressing bandwidth and latency problems noted above.

Different algorithms can be selected for different multimedia types and to increase and/or decrease the matching accuracy of the comparison between the reference and received multimedia content. The algorithms are particularly tuned for different content types to produce differentiating fingerprints in as small a number of data bytes as desired. Some algorithms may generate digital fingerprints that require an absolute match for a positive test, while others may generate digital fingerprints that measure the closeness of the received source to the reference digital fingerprint (and hence source) and thus allow a confidence factor to be determined for the comparison result. The confidence factor or degree of confidence can be user or operator specific. The confidence factor or degree of confidence may, for example, be represented as a percentage of certainty that digital fingerprints match or may be presented as a degree or amount by which the digital fingerprints must match.

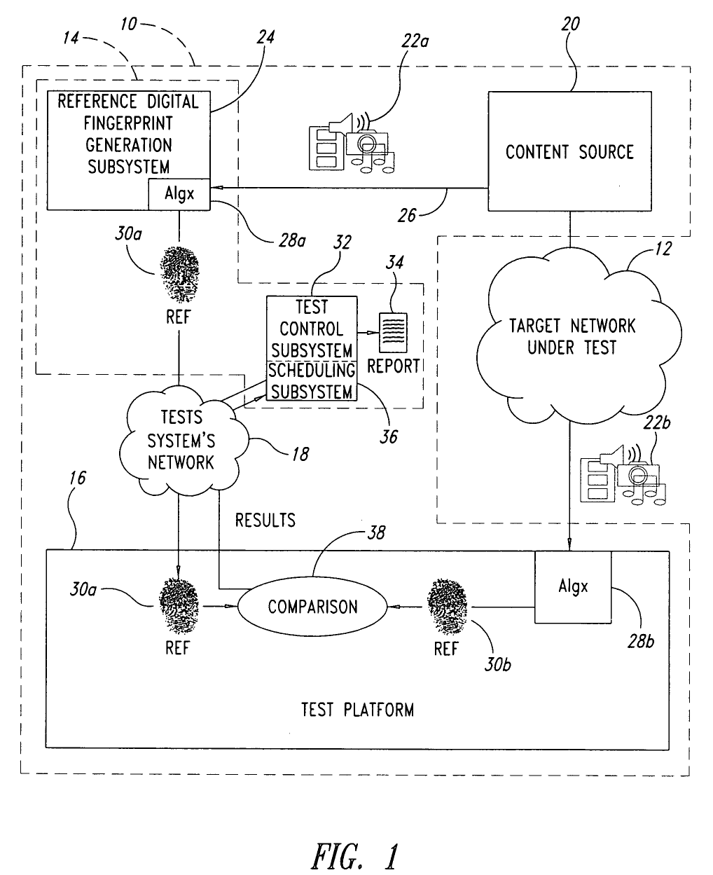

FIG. 1 shows a remote test system 10 operable to test a subject communications network 12 according to one illustrated embodiment.

The test system 10 includes one or more central test control systems 14 and a number of test platforms 16 (only one illustrated in FIG. 1) remotely located with respect to the central test control system 14. The test platforms 16 are communicatively coupled to the test control system 14 via one or more test system communications networks 18 (only one illustrated in FIG. 1). The test system communications network 18 is preferably distinct from the subject communications network 12 under test, so that the test system and the subject communications networks 18, 12, respectively, do not interfere with or degrade the performance of each other.

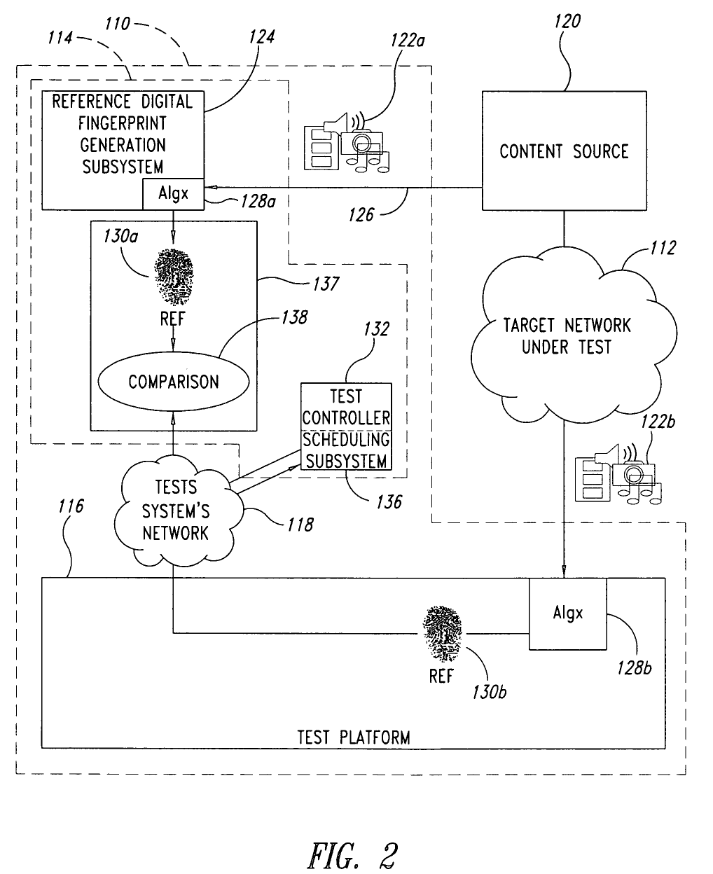

The test system 10 may optionally include a content source 20 that is operable to supply content 22a, 22b, for example multimedia content (i.e., audio, video file, picture, etc). Alternatively, as illustrated in FIG. 2, the content source 20 may be distinct from the test system 10 but responsive thereto. Thus, in some embodiments, separate commercial entities may be responsible for, and/or own the test system 10 and the content source 20. Additionally, some embodiments may include multiple content sources 20.

The test control system 14 may optionally include a reference digital fingerprint generation subsystem 24 communicatively coupled to the content source 20 by a communications link 26 to receive content 22a. The communications link 26 is preferably of a known quality, and may take the form of a high quality communications link to minimize degradation of the multimedia content, for example a communicative link of higher quality that that of the target communications network 12. The reference digital fingerprint generation subsystem 24 executes one or more digital fingerprint algorithms 28a to generate or produce reference digital fingerprints 30a of the content 22a. The reference digital fingerprints 30a are denominated with the term “reference” since the digital fingerprints 30a serve as a basis for comparison, as discussed in detail below.

The test control system 14 may also include a test control subsystem 32 which may include one or more programmed general purpose computing systems, discussed in more detail below. The test control subsystem 32 may interact with the test platforms 16 and/or the reference digital fingerprint generation subsystem 24 via the test system communications network 18 or via some other communications channel, preferably distinct from the target communications network 12.

The test control subsystem 32 may be manually operated by one or more users, and/or be partially or fully automated. The test control subsystem 32 is operable to provide information indicative of a correspondence within a defined degree of confidence between an identity of the multimedia content 22b received over at least a portion of the target cellular telecommunications network 12 and the multimedia content 22a identified for transmission based at least in part on a comparison of a digital fingerprint 30b of the multimedia content 22b received over at least a portion of the target cellular telecommunications network 12 with a respective reference digital fingerprint 30a known before the comparison to correspond to the multimedia content 22 (collectively) identified for transmission via the target cellular telecommunications network 12. For example, the test control subsystem 32 may display and/or print or otherwise generate a report 34 with pertinent information.

The test control subsystem 32 may include a test scheduling subsystem 36. The test scheduling subsystem 36 may be an integral part of the test control subsystem 32, for example sharing a processor, controller and/or memory, or may be distinct therefrom. For example, the test scheduling subsystem 36 may take the form of a separate programmed general purpose computer, either collocated with the test control subsystem 32, or remotely located therefrom and communicatively coupled thereto. The test scheduling subsystem 36 may allow tests of various portions of the subject communications network 12 to be tested automatically, for example during selected hours, such as low use hours or high use hours.

The test platform 16 is located remotely from the content source 20 and the test control subsystem 32. As explained in more detail below, the test platform 16 typically includes one or more wireless communications devices, a processor or other controller and memory to store instructions executable by the processor or other controller. The test platform 16 executes one or more digital fingerprint algorithms 28b to generate or produce digital fingerprints 30 of the content 22b received from the content source 20 via the target communications network 12. The fingerprint algorithms 28b should be the same as the fingerprint algorithms 28a, or should produce approximately the same results.

In the embodiment illustrated in FIG. 1, the test platform 16 is also operable to execute a compare algorithm 38 to compare the digital fingerprint 30b of the content received via the subject communications network 12 with the reference digital fingerprint 30a. The comparison may determine, within some defined degree of confidence, whether the content transmitted from the content source 20 via the subject communications network 12 matches the content that was identified, intended or otherwise instructed or caused to be transmitted.

FIG. 2 shows a remote test system 110 operable to test a subject communications network 112 according to one illustrated embodiment.

The test system 110 includes one or more central test control systems 114 and a number of test platforms 116 (only one illustrated in FIG. 1) remotely located with respect to the central test control system 114. The test platforms 116 are communicatively coupled to the test control system 114 via one or more test system communications networks 118 (only one illustrated in FIG. 1). The test system communications network 118 is preferably distinct from the subject communications network 112 under test, so that the test system and the subject communications networks 118, 112, respectively, do not interfere with or degrade the performance of each other.

The test system 110 can interact with a content source 120 that is operable to supply content 122a, 122b, for example multimedia content (i.e., audio, video file, picture, etc). As illustrated in FIG. 2, the content source 20 may be distinct from the test system 10 but responsive thereto. Thus, in some embodiments, separate commercial entities may be responsible for, and/or own the test system 110 and the content source 120. Additionally, some embodiments may include multiple content sources 120.

The test control system 114 may optionally include a reference digital fingerprint generation subsystem 124 communicatively coupled to the content source 120 by a communications link 126 to receive content 122a. The communications link 126 is preferably of a known quality, and may take the form of a high quality communications link to minimize degradation of the multimedia content, for example a communications link of higher quality that that of the target communications network 112. The reference digital fingerprint generation subsystem 124 executes one or more digital fingerprint algorithms 128a to generate or produce reference digital fingerprints 130a of the content 122a. The reference digital fingerprints 130a are denominated with the term “reference” since the digital fingerprints 130a serve as a basis for comparison, as discussed in detail below.

The test control system 114 may also include a test control subsystem 32 which may include one or more programmed general purpose computing systems, discussed in more detail below. The test control subsystem 132 may interact with the test platforms 116 and/or the reference digital fingerprint generation subsystem 124 via the test system network 118 or via some other communications channel, preferably distinct from the target communications network 112.

The test control subsystem 132 may be manually operated by one or more users, and/or be partially or fully automated. The test control subsystem 132 is operable to provide information indicative of a correspondence within a defined degree of confidence between an identity of the multimedia content 122b received over at least a portion of the target cellular telecommunications network 112 and the multimedia content 122a identified for transmission based at least in part on a comparison of a digital fingerprint 130b of the multimedia content 122b received over at least a portion of the target cellular telecommunications network 112 with a respective reference digital fingerprint 130a known before the comparison to correspond to the multimedia content 122 (collectively) identified for transmission via the target cellular telecommunications network 112. For example, the test control subsystem 132 may display and/or print or otherwise generate a report 134 with pertinent information.

The test control subsystem 132 may include a test scheduling subsystem 136. The test scheduling system 136 may be an integral part of the test control subsystem 132, for example sharing a processor, controller, and/or memory, or may be distinct therefrom. For example, the test scheduling system 136 may take the form of a separate programmed general purpose computer, either collocated with the test control subsystem 132, or remotely located therefrom and communicatively coupled thereto. The test scheduling subsystem 136 may allow tests of various portions of the subject communications network 112 to be tested automatically, for example during selected hours, such as low use hours or high use hours.

The test platform 116 is located remotely from the content source 120 and the test control subsystem 132. As explained in more detail below, the test platform 116 typically includes one or more wireless communications devices, a processor or other controller and memory to store instructions executable by the processor or other controller. The test platform 116 executes one or more digital fingerprint algorithms 128b to generate or produce digital fingerprints 30 of the content 122b received from the content source 120 via the target communications network 112. The fingerprint algorithms 128b should be the same as the fingerprint algorithms 128a, or should produce approximately the same results.

In the embodiment illustrated in FIG. 2, the test platform 116 is also operable to transmit the digital fingerprint 30b of the content received via the subject communications network 12 to the test control system 114. A comparison subsystem 137 of the test control system 114 executes a comparison algorithm 138. The comparison algorithm may determine, within some defined degree of confidence, whether the content transmitted from the content source 120 via the subject communications network 112 matches the content that was identified, intended or otherwise instructed or caused to be transmitted. While illustrated separately, the comparison subsystem 137 may in some embodiments be executed by the test controller 132 or some other suitable processing system or device.

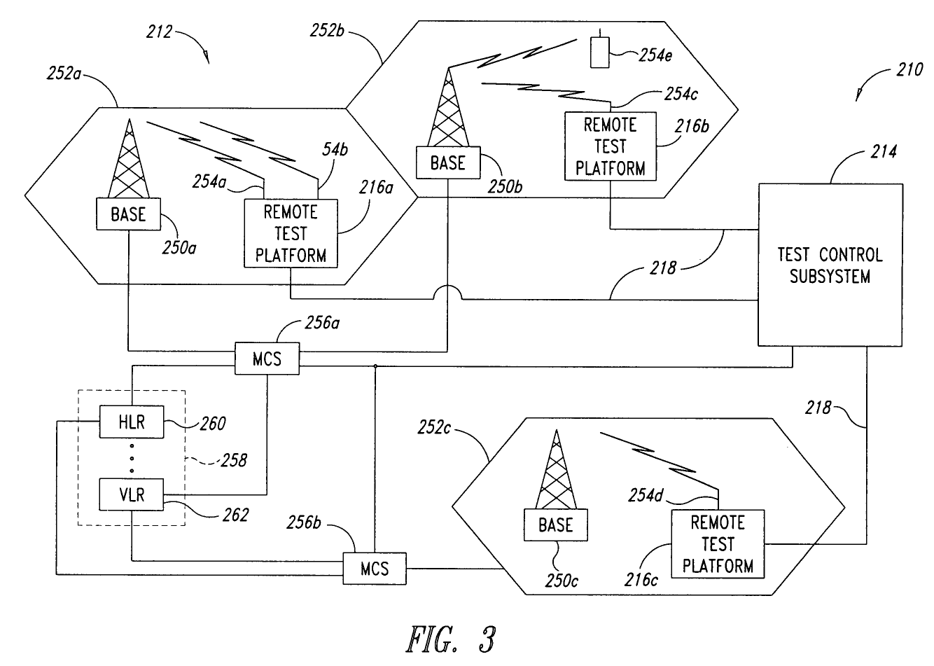

FIG. 3 shows a test system 210 for testing a subject communications network in the form of a cellular communications network 212, according to one illustrated embodiment. Many aspects of the test system 210 are the same as or similar to those described above, and so will not be discussed in the interest of brevity and clarity. Only significant differences will be described. Additionally, cellular communications networks are well known in the art, and only selective elements or portions will be described herein in the interest of brevity and clarity.

The cellular communications network 212 typically comprises a number of geographically distributed base stations 250a-250c (collectively 250) each with a respective antenna tower, antennas, transceiver radios (i.e., base transceiver station), and radio controllers (i.e., base station controller). Each base station 250a-250c typically defines a cell 252a-252c (collectively 252), although the boundaries of cells 252 are not distinct and cells 252 may overlap to some degree. The cells 252 can vary in size depending upon terrain, capacity, demands, and other factors. The radio frequency that is assigned to one cell 252 can be limited to the boundary of that cell 252 by controlling the transmission power. While only three cells 252a-252c are illustrated in the Figure, most cellular communications networks comprise hundreds or thousands of cells.

The base stations 250 each establish wireless communications with one or more wireless communications devices 254a-254e present in the respective cell 252, if any. One or more of the wireless communications devices 254a-254d may be part of one or more test platforms 216a-216c, such as the test platforms described above and described in further detail below. One or more of the wireless communications devices 254e may be standalone devices, for example a convention cellular phone, wireless PDA, or otherwise wireless device such as an antitheft location tracking device. For example, a first base station 250a may provide wireless communications between two wireless communications devices 254a, 254b that are each part of a first test platform 216a. A second base station 250b may provide wireless communications between a wireless communications device 254c that is part of a second test platform 216b and a standalone device 254e. A third base station 250c may provide wireless communications between a wireless communications device 254d that is part of a third test platform 216c and a service, for example an automated call service such as call waiting, voicemail, directory assistance, 911, interactive voice response, etc.

The base stations 250 are typically communicatively coupled via one or more mobile telephone switching centers (“MSC”) 256a, 256b (collectively 256), located at one or more mobile telephone switching offices (“MTSO”) which route the transmissions. Additionally, the cellular telecommunications network 212 may include one or more base cellular centers (“BSC”), not shown, coupled between the base stations 250 and the MSCs 256, for example, to handle call handoff. For convenience, the description will refer only to MSC, although one skilled in the art will recognize that many of the functions described as being performed by the MSC may alternatively or additionally be performed by the BSC.

The MSC 256 constantly monitors signal strength of both the caller and receiver, locating the next cell site when signal strength fades, and automatically rerouting the communications to maintain the communications link. For example, when a wireless communications client 254e moves from one cell to another cell (e.g., 252b to 252a), a computer at the MSC 256 monitors the movement, and transfers (i.e., handoff) the phone call from the existing base station (e.g., 250b) to the new base station (e.g., 250a) at the appropriate time. The transfer will typically include switching of radio frequency. The transfer should be transparent to the users. Thus, the MSC 256 acts like a standard PSTN or ISDN switching node, and additionally provides mobile subscriber related functions such as registration, authentication, location updating, handoffs, and call routing to roaming subscribers.

The wireless communications devices 254 rely on wireless communications service providers for providing subscribed services. The wireless communications service providers operate wireless communications service provider systems 258 that provide for registration, authentication, location updating, handovers, and call routing. The wireless communications service provider systems typically employ a Home Location Register (“HLR”) 260 and a Visitor Location Register (“VLR”) 262 to provide call routing and roaming. The HLR 260 contains all of the administrative information for each subscriber registered with the wireless communications service provider, along with current location information for a wireless communications device currently associated with the subscriber. The VLR 262 contains selected administrative information from the HLR 260 that is required for call control and for providing subscribed services for each wireless communications device currently within a geographical area service by the VLR 262.

The MSC 256 also typically employs a database (e.g., AuC) for authenticating subscribers, and a separate database (e.g., EIR) for verifying the equipment. The MSC 256 typically allocates a routing number to each of the calls that the MSC 256 is switching. While the routing number is different than the unique subscriber identifier (e.g., IMSI) and the unique equipment identifier (e.g., IMEI), MTSO may define a relationship between the routing number and the subscriber and/or equipment identifiers associated with each wireless communications client 254. These identifiers allow the MSC 256 to track and coordinate all wireless communications clients 254 in its service area, and also allows the MSC 256 to determine the validity of the call and caller.

The cellular telecommunications network 212 may include wireless as well as landline communications links. While the cellular telecommunications network 212 provides wireless communications service, and landline networks typically provide conventional communications service, such as conventional telephone service, these networks and services generally overlap. For example, a wireless communications user can place a call through the cellular telecommunications network to the landline network to establish a communications link with a conventional communications device, such as a telephone. Conversely, a conventional communications device user can place a call through a landline network to a cellular telecommunications network to establish a communications link with a wireless communications device such as a cellular phone. Thus, the cellular telecommunications network 212 often includes communications links that may be considered part of the landline network, including POTS lines, trunk lines, and optical fiber to name a few.

As illustrated in FIG. 3, the test platforms 216 may be located in one or more cells of the cellular telecommunications network 212 to test the target cellular communications network 212. The test platforms 216 may be communicatively coupled to one or more central test control subsystems 214 via a test communications network 218 that is distinct from the target communications network 212. The testing system 210 may take a form similar to that illustrated in FIG. 1 or 2, or some other form suitable for testing the target communications network 212.

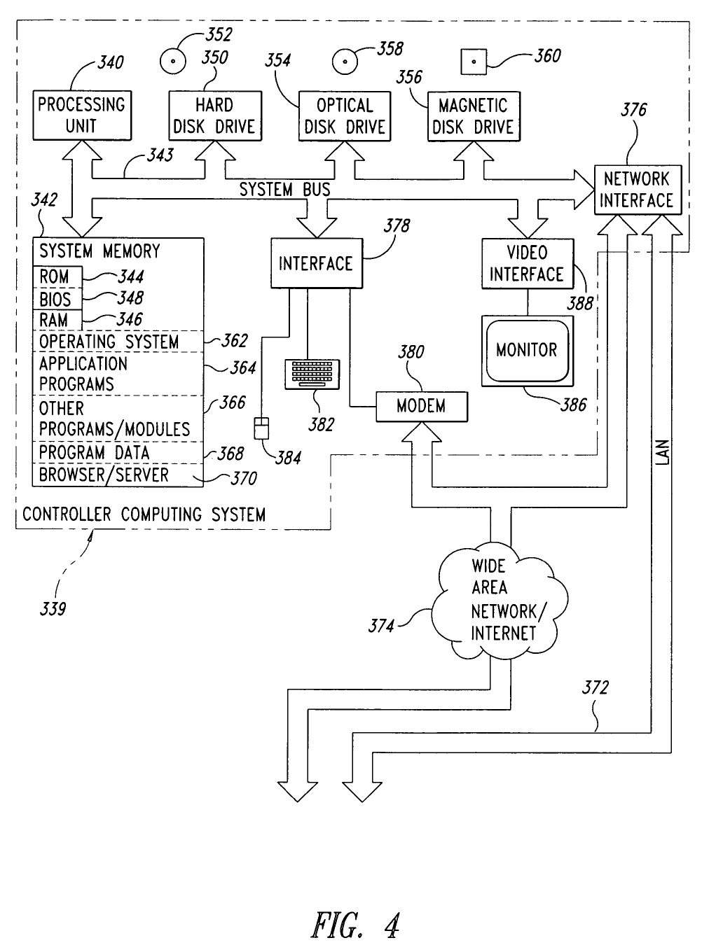

FIG. 4 and the following discussion provide a brief and general description of a suitable computing environment in which embodiments of the invention can be implemented, particularly those of FIGS. 1, 2 or 3. Although not required, embodiments of the invention will be described in the general context of computer-executable instructions, such as program application modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, and the like. The invention can be practiced in distributed computing environments where tasks or modules are performed by remote processing devices, which are linked through a communications network. In a distributed computing environment, program modules may be located in both local and remote memory storage devices.

The subject matter of FIG. 4 and the following discussion may be generally or specifically relevant to computing systems suitable for use as any one or more of the test systems 10, 110, 210, test control subsystems 32, 132, reference digital fingerprint generation subsystems 24, 124, 214, content source 20, 12, and/or test platforms 16, 116. In the interest of brevity, only significant differences in hardware and operation of the various computing systems 26, 32, 34, 36 will be set out and discussed separately.

Referring to FIG. 4, a computing system 339 includes a processing unit 340, a system memory 342, and a system bus 343 that couples various system components including the system memory 342 to the processing unit 340. The computing system 339 will at times be referred to in the singular herein, but this is not intended to limit the application of the invention to a single computing system 339 since in typical embodiments, there will be more than one computing system 339 or other device involved. The testing system 10, 110, 210 may employ other computing systems, such as conventional and personal computers, where the size or scale of the system allows. The processing unit 340 may be any logic processing unit, such as one or more central processing units (“CPUs”), digital signal processors (“DSPs”), application-specific integrated circuits (“ASICs”), etc. Unless described otherwise, the construction and operation of the various blocks shown in FIG. 4 are of conventional design. As a result, such blocks need not be described in further detail herein, as they will be understood by those skilled in the relevant art.

The system bus 343 can employ any known bus structures or architectures, including a memory bus with memory controller, a peripheral bus, and a local bus. The system memory 342 includes read-only memory (“ROM”) 344 and random access memory (“RAM”) 346. A basic input/output system (“BIOS”) 348, which can form part of the ROM 344, contains basic routines that help transfer information between elements within the computing system 339, such as during startup.

The computing system 339 also includes a hard disk drive 350 for reading from and writing to a hard disk 352, and an optical disk drive 354 and a magnetic disk drive 356 for reading from and writing to removable optical disks 358 and magnetic disks 360, respectively. The optical disk 358 can be read by a CD-ROM, while the magnetic disk 360 can be a magnetic floppy disk or diskette. The hard disk drive 350, optical disk drive 354 and magnetic disk drive 356 communicate with the processing unit 340 via the bus 343. The hard disk drive 350, optical disk drive 354 and magnetic disk drive 356 may include interfaces or controllers (not shown) coupled between such drives and the bus 343, as is known by those skilled in the relevant art. The drives 350, 354 and 356, and their associated computer-readable media, provide non-volatile storage of computer readable instructions, data structures, program modules and other data for the computing system 339. Although the depicted computing system 339 employs hard disk 352, optical disk 358 and magnetic disk 360, those skilled in the relevant art will appreciate that other types of computer-readable media that can store data accessible by a computer may be employed, such a magnetic cassettes, flash memory cards, digital video disks (“DVD”), Bernoulli cartridges, RAMs, ROMs, smart cards, etc.

Program modules can be stored in the system memory 342, such as an operating system 362, one or more application programs 364, other programs or modules 366 and program data 368. The system memory 342 may also include a Web client or browser and/or server 370 for permitting the computing system 339 to access and exchange data with sources such as Websites of the Internet, corporate Intranets, or other networks as described below, as well as other server applications on server computers such as those further discussed below. The browser 370 in the depicted embodiment is markup language based, such as hypertext markup language (“HTML”), extensible markup language (“XML”) or wireless markup language (“WML”), and operates with markup language that use syntactically delimited characters added to the data of a document to represent the structure of the document. A number of Web clients or browsers as well as servers are commercially available such as Netscape Navigator from America Online and Internet Explorer available from Microsoft, Redmond, Wash.

While shown in FIG. 4 as being stored in the system memory 342, the operating system 362, application program 364, and other programs/modules 366, program data 368 and browser 370 can be stored on the hard disk 352 of the hard disk drive 350, the optical disk 358 of the optical disk drive 354 and/or the magnetic disk 360 of the magnetic disk drive 356.

The computing system 339 can operate in a networked environment using logical connections to one or more remote computers, such as the wireless communications clients 254, test platforms 16, 116, 216. The computing system 339 is logically connected to one or more other computing systems 339 under any known method of permitting computers to communicate, such as through a local area network (“LAN”) 372, or a wide area network (“WAN”) including, for example, the Internet 374. Such networking environments are well known including wired and wireless enterprise-wide computer networks, intranets, extranets, and the Internet. Other embodiments include other types of communications networks such as telecommunications networks, cellular networks, paging networks, and other mobile networks. When used in a LAN networking environment, the computing system 339 is connected to the LAN 372 through an adapter or network interface 376 (communicatively linked to the bus 343). When used in a WAN networking environment, the computing system 339 may include an interface 378 and modem 380 or other device, such as the network interface 376, for establishing communications over the WAN/Internet 374.

The modem 380 is shown in FIG. 4 as communicatively linked between the interface 378 and the WAN/Internet 374. In a networked environment, program modules, application programs, or data, or portions thereof, can be stored in the computing system 339 for provision to the networked computers. In one embodiment, the computing system 339 is communicatively linked through the LAN 372 or WAN/Internet 374 with TCP/IP middle layer network protocols; however, other similar network protocol layers are used in other embodiments, such as user datagram protocol (“UDP”). Those skilled in the relevant art will readily recognize that the network connections shown in FIG. 4 are only some examples of establishing communications links between computers, and other links may be used, including wireless links.

An operator can enter commands and information into the computing system 339 through optional input devices, such as a keyboard 382, and a pointing device, such as a mouse 384. Other input devices can include a microphone, joystick, scanner, etc. These and other input devices are connected to the processing unit 340 through the interface 378, such as a serial port interface that couples to the bus 343, although other interfaces, such as a parallel port, a game port, or a wireless interface, or a universal serial bus (“USB”) can be used. A monitor 386 or other display device is coupled to the bus 343 via a video interface 388, such as a video adapter. The computing system 339 can include other output devices, such as speakers, printers, etc.

The various elements of the test system 14, 114, 214 may each be implemented using a computing system 339 similar to that described above where the differences in operation are typically embodied in the particular application programs, other programs/modules, program data and/or operating system loaded in the system memory 342, for example whether the comparison algorithm is executed at the test platform 16, 116, 316 or test control subsystem 32, 132, and as set out in the discussion of operation which follows.

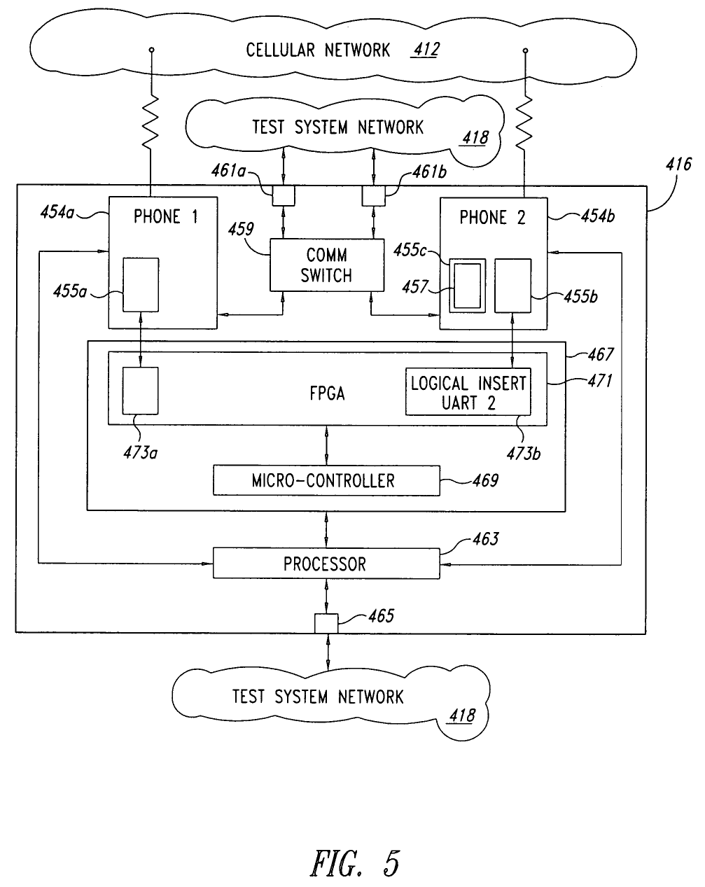

FIG. 5 shows a logical representation of the remote test platform 416 suitable for implementing the test platforms 16, 116, 216 discussed above.

The remote test platform 416 includes a first and a second wireless communications device 454a, 454b (collectively 454). In the illustrated embodiment, the wireless communications devices 454 can take the form of cellular telephones, with or without their individual housings, keypads and/or displays, each of the cellular telephones including one or more subscriber identity module (SIM) interfaces 455a-455c, respectively, such a SIM slots, electrical contacts such as pins, optical transceivers, or other interfaces. In some embodiments, the SIM interfaces 455a, 455b may be empty, the wireless communications device 454 completely relying on remote access to SIMs, while in other embodiments one or more SIM interfaces 455c may contain a SIM 457 for local access. The wireless communications devices 454 wirelessly communicate via the cellular network 412.

The remote test platform 416 includes communications switch 459 such as an audio switch which can cross-couple an input and output between the two wireless communications devices 454a, 454b. The communications switch 459 can also couple audio and data signals received at one or more physical and/or virtual ports 461a, 461b by way of, for example, a test system network 418 such as a landline network, IP network, voice-over-IP network, wireless modem or wireless data communications network such as GPRS, 1XRTT to name a few. The test system network 418 is preferably distinct and separate from the subject communications network 412 being tested.

The remote test platform 416 also includes a processor 463, which receives commands and data at a port 465 by way of the network 108. The processor 463 controls the wireless communication devices 454a, 454b, as described in detail below. The processor 463 also couples to a bridge 467 that includes a controller such as a micro-controller 469, and a field programmable gate array 471. The field programmable gate array 471 includes logical insertion UARTs 473a, 473b which provide information from a remote SIM 457, such as subscriber identity information and/or subscriber configuration information, in a serial stream at respective SIM interfaces 455a, 455b.

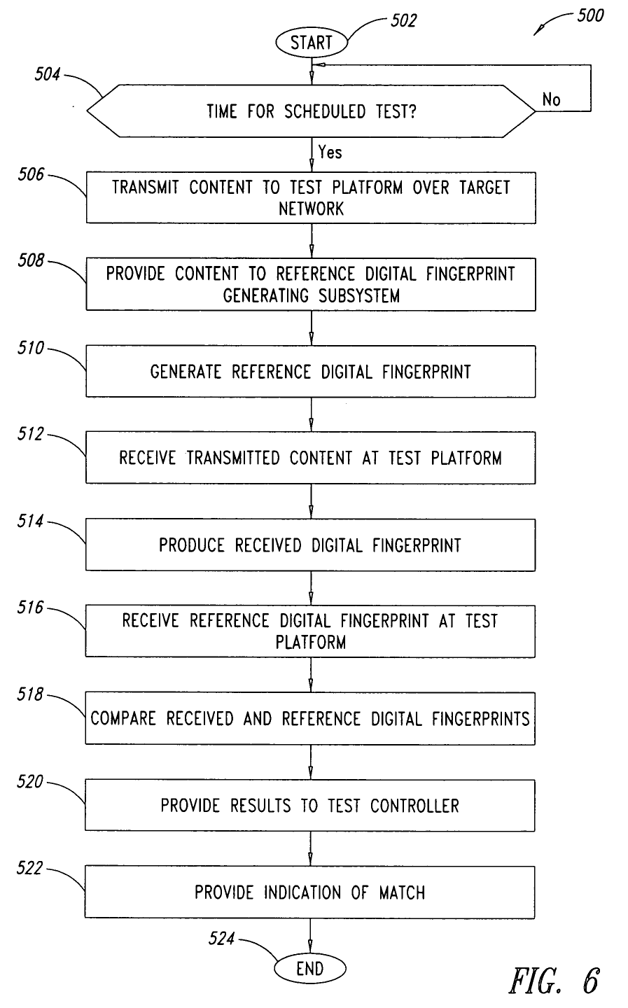

FIG. 6 shows a method 500 of operating a test system 10 such as that illustrated in FIG. 1, according to one illustrated embodiment, starting at 502.

Optionally, at 504, the test scheduler subsystem 36 determines whether a time for running a scheduled test has occurred. If not, a wait loop is executed, with control passing back to 504. If the time has occurred, control passes to 506.

At 506, the test control subsystem 14 identifies content or otherwise causes the content source 20 to transmit content 22b to the remotely located platform 16 via the target communications network 12 that is being tested. At 508, the central test control system 14 causes the content source 20 to transmit content 22a to the reference digital fingerprint generation subsystem 24, preferably via a high quality communications link 26. In some embodiments, the content source 20 may automatically provide the content 22a as part of transmitting the content 22b via the subject communications network 12. At 510, the reference digital fingerprint generation subsystem 24 executes the algorithm 28a to produce the reference digital fingerprint 30a. In some embodiments, the reference digital fingerprints 30a may be pre-existing, and stored either by the content source 20, the central test control system 14, or some other element.

At 512, the content 22b is received at the test platform 16 via the target communications network 12. At 514, the test platform 16 executes the algorithm 28b to produce the digital fingerprint 30b of the content 22b received via the target communications network 12.

At 516, the test platform 16 receives the reference digital fingerprint 30a. At 518, the comparison subsystem or function of the test platform 16 compares the received and the reference digital fingerprints 30b, 30a, respectively. At 520, the test platform 16 provides results to the test control subsystem 32, for example via the test system communications network 18.

At 522, the test control subsystem 32 provides an indication of whether the content 22b received via the target communications network 12 is the same as the content that the test system 10 identified, indicated, or otherwise caused to be transmitted. The method 500 terminates at 524. The method 500 may be executed continuously, and/or may be executed as one or more threads or processes. The acts of the method 500 may be executed in a different order, and the method may include additional acts and/or omit some acts.

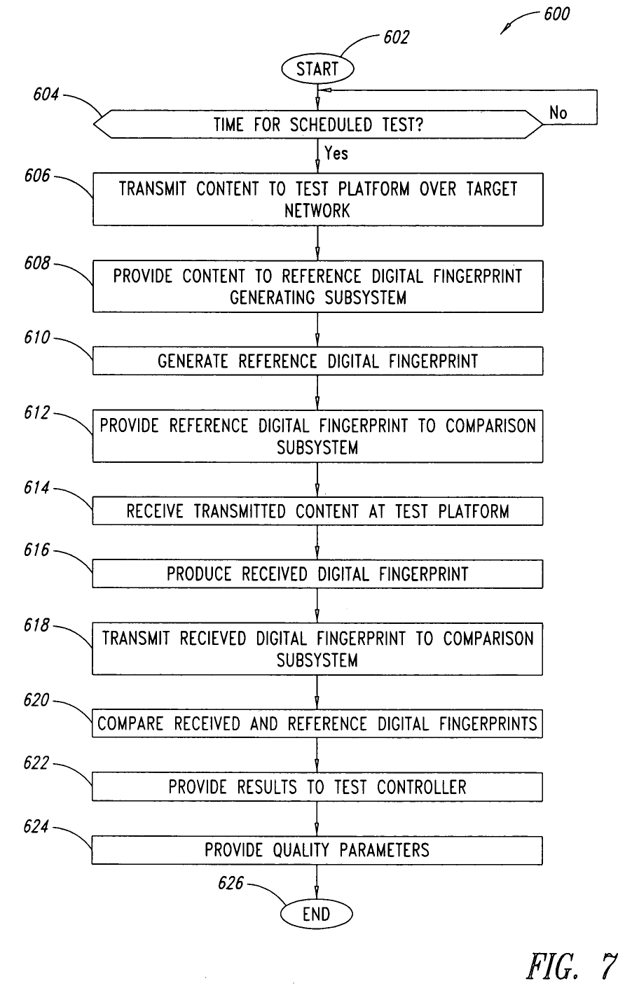

FIG. 7 shows a method 600 of operating a test system such as that illustrated in FIG. 2, according to one illustrated embodiment, starting at 602.

Optionally, at 604, the test scheduler subsystem 136 determines whether a time for running a scheduled test has occurred. If not, a wait loop is executed, with control passing back to 604. If the time has occurred, control passes to 606.

At 606, the test control subsystem 114 identifies content or otherwise causes the content source 120 to transmit content 122b to the remotely located platform 116 via the target communications network 112 that is being tested. At 608, the central test control system 114 causes the content source 120 to transmit content 122a to the reference digital fingerprint generation subsystem 124, preferably via a high quality communications link 126. In some embodiments, the content source 120 may automatically provide the content 122a as part of transmitting the content 122b via the subject communications network 112. At 610, the reference digital fingerprint generation subsystem 124 executes the algorithm 128a to produce the reference digital fingerprint 130a. In some embodiments, the reference digital fingerprints 130a may be pre-existing, and stored either by the content source 120, the central test control system 114, or some other element.

At 612, the test control system 114 provides the reference digital fingerprint 130a to the comparison subsystem or function 138 of the test control system 114.

At 614, the content 122b is received at the test platform 116 via the target communications network 112. At 616, the test platform 116 executes the algorithm 128b to produce the digital fingerprint 130b of the content 122b received via the target communications network 112. At 618, the test platform 116 transmits or otherwise provides the digital fingerprint 130b of the content 122b received via the target communications network 112 to the comparison subsystem or function 138 of the test control system 114.

At 620, the comparison subsystem or function 138 compares the received and the reference digital fingerprints 30b, 30a, respectively. At 622, the comparison subsystem or function 138 provides the results of the comparison to the test control subsystem 132. At 624, the test control subsystem 132 provides an indication of whether the content 122b received via the target communications network 112 is the same as the content that the test system 110 identified, indicated, or otherwise caused to be transmitted. The method 600 terminates at 626. The method 600 may be executed continuously, and/or may be executed as one or more threads or processes. The acts of the method 600 may be executed in a different order, and the method may include additional acts and/or omit some acts.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein can be applied to other communications testing systems, not necessarily the exemplary testing system for remotely testing a cellular communications network generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

As described above, the equipment at the measurement/comparison point may allow many different algorithms to be stored and used upon control by the test system control point. The test equipment will select the appropriate algorithm to generate the received content's fingerprint. This algorithm selection may be by explicit identification, or it may be by implicit identification through the nature and coding of the content fingerprint.

As used herein and throughout the claims, multimedia content is not limited to combinations of digital audio, visual and/or other media, but includes any human perceptible content including audio only, visual or video only, combinations of audio and visual or video, electronic mail (e-mail), image files in various formats, text files in various formats, streaming media, and other representations of information, which may or may not originally be in digital form.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Pat. Nos. 5,875,398; 5,918,223; 6,230,006; 6,430,410; 6,542,738; 6,788,934; 6,834,308; 6,836,670; and 6,968,337, U.S. Provisional Patent Application Ser. No. 60/654,526 as well as U.S. patent application Publication Ser. Nos. 2003/18709; 2003/33321; 2003/37010; 2003/135623; and 2004/163106 are incorporated herein by reference, in their entirety. Aspects of the above embodiments can be modified, if necessary, to employ systems, circuits and concepts of the various patents, applications and publications to provide yet further embodiments.

These and other changes can be made in light of the above-detailed description. In general, in the following claims, the terms used should not be construed to be limited to the specific embodiments disclosed in the specification and the claims, but should be construed to include all remote testing systems that operated in accordance with the claims. Accordingly, the invention is not limited by the disclosure, but instead its scope is to be determined entirely by the following claims.

1. A method for testing a target communications network, the method comprising:
causing content to be transmitted from a content source to a test platform via the target communications network that is being tested;
producing a digital fingerprint representative of the content received at the test platform via the target communications network;
comparing the digital fingerprint of the content received at the test platform via the target communications network to a reference digital fingerprint of the content, where the reference digital fingerprint of the content is representative of the content caused to be transmitted; and
determining based at least in part on the comparison of the digital fingerprint of the content received at the test platform via the target communications network to a reference digital fingerprint of the content whether the content as received via the target communications network matches the content caused to be transmitted, within a defined degree of confidence.

2. The method of claim 1 wherein the test platform is remotely located from the content source, and further comprising:
transmitting the reference digital fingerprint of the content to the test platform, wherein comparing the digital fingerprint representative of the content received at the test platform via the target communications network to the reference digital fingerprint comprises comparing the digital fingerprint representative of the content received at the test platform via the target communications network to the reference digital fingerprint at the test platform.

3. The method of claim 1 wherein the test platform is remotely located from the content source, and further comprising:
transmitting the digital fingerprint representative of the content received at the test platform via the target communications network from the test platform to a comparison subsystem of a test server, wherein comparing the digital fingerprint representative of the content received at the test platform via the target communications network to the reference digital fingerprint comprises comparing the digital fingerprint representative of the content received at the test platform via the target communications network to the reference digital fingerprint at the test server.

4. The method of claim 1 wherein comparing the digital fingerprint representative of the content received at the test platform via the target communications network to a reference digital fingerprint representative of the content comprises determining an identity of the content source.

5. The method of claim 1 wherein comparing the digital fingerprint representative of the content received at the test platform via the target communications network to a reference digital fingerprint representative of the content comprises determining at least one parameter representative of differences between the content from the content source and the content as received at the test platform via the target network.

6. The method of claim 1, further comprising:
producing information indicative of a result of the comparison of the digital fingerprint representative of the content received at the test platform via the target communications network to the reference digital fingerprint.

7. The method of claim 1, further comprising:
receiving the content from the content source over a connection of a known quality, and
producing the reference digital fingerprint of the content from the content as received over the connection of the known quality.

8. The method of claim 7 wherein receiving the content from the content source over a connection of a known quality comprises receiving multimedia content from a source of multimedia content over a high quality connection.

9. The method of claim 7 wherein the reference digital fingerprint is produced according to a digital fingerprinting algorithm and the digital fingerprint representative of the content received at the test platform via the target communications network is produced according to the same digital fingerprinting algorithm.

10. A method for testing a target cellular telecommunications network comprising a plurality of geographically distributed base stations defining geographic cells, a content source, and a test system comprising at least one central test controller and a number of remote test platforms, the remote test platforms respectively located in a number of the cells of the target cellular telecommunications network, the method comprising:
as part of a test, identifying content to be transmitted from a content source to a test platform via the target cellular telecommunications network that is being tested;
receiving transmitted content at a first one of the test platforms via the target cellular telecommunications network that is being tested;
at the first one of the test platforms, producing a digital fingerprint representative of the transmitted content as received at the test platform via the target cellular telecommunications network; and
comparing the digital fingerprint representative of the transmitted content as received at the test platform via the target cellular telecommunications network with a reference digital fingerprint known before the comparison to correspond to the identified content to be transmitted, where the reference digital fingerprint is representative of the identified content to be transmitted without having traversed the target cellular telecommunications network.

11. The method of claim 10, further comprising:
transmitting the reference digital fingerprint to the first one of the test platforms, and wherein comparing the digital fingerprint representative of the transmitted content as received at the test platform via the target cellular telecommunications network with the reference digital fingerprint comprises comparing the digital fingerprint representative of the transmitted content as received at the test platform via the target cellular telecommunications network with the reference digital fingerprint at the first one of the test platforms.

12. The method of claim 11 wherein transmitting the reference digital fingerprint to the first one of the test platforms comprises transmitting the reference digital fingerprint to the first one of the test platforms over a communications channel that is not part of the target cellular telecommunications network.

13. The method of claim 11 wherein transmitting the reference digital fingerprint to the first one of the test platforms comprises transmitting the reference digital fingerprint to the first one of the test platforms over a communications channel having a high quality than a quality of the target cellular telecommunications network.

14. The method of claim 10, further comprising:
storing the reference digital fingerprint at the first one of the test platforms before receiving the transmitted content at the first one of the test platforms.

15. The method of claim 10, further comprising:
transmitting the digital fingerprint representative of the transmitted content as received at the test platform via the target cellular telecommunications network from the first one of the test platforms to a test server, and wherein comparing the digital fingerprint representative of the transmitted content as received at the test platform via the target cellular telecommunications network with the reference digital fingerprint comprises comparing the digital fingerprint representative of the transmitted content as received at the test platform via the target cellular telecommunications network with the reference digital fingerprint at the test server.

16. The method of claim 10 wherein transmitting the digital fingerprint representative of the transmitted content as received at the test platform via the target cellular telecommunications network from the first one of the test platforms to a test server comprises transmitting the digital fingerprint representative of the transmitted content as received at the test platform via the target cellular telecommunications network from the first one of the test platforms to a test server over a communications channel that is not part of the target cellular telecommunications network.

17. The method of claim 10, further comprising:
determining based at least in part on the comparison of the digital fingerprint of the content received at the test platform via the target cellular telecommunications network to a reference digital fingerprint of the content whether the content as received via the target cellular telecommunications network matches the content identified to be transmitted, within a defined degree of confidence.

18. A system for remotely testing a target communications network, the system comprising:
means for indicating content to be transmitted from a content source to a test platform via the target communications network that is being tested;
means for generating a digital fingerprint representative of a transmitted content as received via the target communications network; and
means for comparing the digital fingerprint representative of the transmitted content as received via the target communications network with a reference digital fingerprint, the reference digital fingerprint known prior to the comparing to be representative of the content indicated by the means for indicating.

19. The system of claim 18 wherein the transmitted content is received via the target communications network at the test platform, the test platform remote from the content source, and further comprising:
means for transmitting the reference digital fingerprint to the test platform, wherein the means for comparing the digital fingerprint representative of the transmitted content as received via the target communications network with the reference digital fingerprint is located at the test platform.

20. The system of claim 18 wherein the transmitted content is received via the target communications network at the test platform, the test platform remote from the content source, and further comprising:
means for transmitting the digital fingerprint representative of the transmitted content as received via the target communications network from the test platform to a test server, wherein the means for comparing the digital fingerprint representative of the transmitted content as received via the target communications network with the reference digital fingerprint is located at the test server.

21. The system of claim 18 wherein the means for generating a digital fingerprint representative of the transmitted content as received via the target communications network comprises a processor and a processor-readable medium located at the test platform remote from the content source.

22. The system of claim 21 wherein means for comparing the digital fingerprint representative of the transmitted content as received via the target communications network with a reference digital fingerprint comprises a processor and a processor-readable medium located at test server remote from the test platform.

23. The system of claim 18, further comprising:
the test platform remotely located with respect to the server, the test platform comprising a processor and at least one wireless communications device, and wherein the means for generating a digital fingerprint representative of the transmitted content as received via the target communications network comprises a set of processor executable instructions stored in at least one processor-readable medium communicatively coupled to the processor.

24. The system of claim 23 wherein the means for comparing the digital fingerprint representative of the transmitted content as received via the target communications network with a reference digital fingerprint comprises a set of processor executable instructions stored in at least one processor-readable medium communicatively coupled to the processor.

25. A system for remotely testing a target cellular telecommunications network, the system comprising:
a plurality of test platforms geographically dispersed in at least a portion of a range of the target cellular telecommunications network, the test platforms operable to receive multimedia content via the target cellular telecommunications network, and further operable to produce a digital fingerprint of the multimedia content as received by the test platform over the target cellular telecommunications network; and
a test control system operable to identify multimedia content for transmission via the target cellular telecommunications network, and further operable to provide information indicative of a correspondence within a defined degree of confidence between an identity of the multimedia content received over at least a portion of the target cellular telecommunications network and the multimedia content identified for transmission based at least in part on a comparison of the digital fingerprint of the multimedia content received over at least a portion of the target cellular telecommunications network with a respective reference digital fingerprint known before the comparison to correspond to the multimedia content identified for transmission via the target cellular telecommunications network.

26. The system of claim 25 wherein the test platforms are further operable to receive the reference digital fingerprint and to compare the digital fingerprint of the multimedia content received over at least a portion of the target cellular telecommunications network with the reference digital fingerprint.

27. The system of claim 25 wherein the test platforms are further operable to transmit the digital fingerprint of the multimedia content received over at least a portion of the target cellular telecommunications network over a communications channel separate from the target cellular telecommunications network.

28. The system of claim 27 wherein the test controller is operable to receive the digital fingerprint of the multimedia content received over at least a portion of the target cellular telecommunications network from the test platforms and are operable to compare the digital fingerprint of the multimedia content received over at least a portion of the target cellular telecommunications network with the reference digital fingerprint.

29. The system of claim 25, further comprising:
a reference digital fingerprint generating subsystem coupleable by a high quality connection to a source of multimedia content, and operable to produce a reference digital fingerprints of the multimedia content received from the source of multimedia content over the high quality connection.

30. The system of claim 25, further comprising:
a reference fingerprint creating system coupleable by a high quality connection to a source of multimedia content, and operable to produce a reference digital fingerprint of the multimedia content received from the source of multimedia content via the high quality connection.

31. The system of claim 25, further comprising:
the source of multimedia content.

32. The system of claim 25, further comprising:
a comparison subsystem; and
a scheduling subsystem operable to cause the transmission of the multimedia content identified for transmission via the target cellular telecommunications network according to a user defined schedule and further operable to provide identification of the content to the comparison subsystem.
